(19) United States
(12) Patent Application Publication
(10) Pub. No.: US 2008/0022325 A1
(43) Pub. Date: Jan. 24, 2008

(54) Portable computing platform including wireless communication functionality and extended multimedia broadcast multicast service functionality

(75) Inventors: Robert Ober, San Jose, CA (US); R. Stephen Polzin, San Jose, CA (US)

Correspondence Address: MEYERTONS, HOOD, KIVLIN, KOWERT & GOETZEL (AMD), P.O. BOX 398, AUSTIN, TX, 78767-0398, US

(73) Assignee: Advanced Micro Devices, Inc.

(21) Appl. No.: 11/478,696

(22) Filed: Jun. 30, 2006

(51) Int. Cl. H04N 7/16; G06F 13/00; H04N 7/173; H04N 7/18; H04N 5/445; G06F 3/00

(52) U.S. Cl. 725/81; 725/38; 725/133; 725/141; 725/153

(57) ABSTRACT

A portable computer system such as a laptop computer, for example, includes a processor and a wireless module. The wireless module may establish a wireless connection to a wireless network and may receive video data such as an MBMS video stream, for example, via one or more wireless channels. The portable computer system also includes a first display and a second display. The second display having a lower resolution than the first display, may display first video images associated with the video data. Upon request by a user of the portable computer system, the wireless module may further receive enhancement video data via one or more additional wireless channels (e.g., side channels) of the wireless connection. The first display may display second video images associated with a combination of the video data and the enhancement video data. The second video images have a higher resolution than the first video images.

### BACKGROUND OF THE INVENTION

1. Field of the Invention

This invention relates to portable computing systems and, more particularly, to wireless communication functionality of portable computing systems.

2. Description of the Related Art

Today's cellular telephones and other mobile communication handsets have video capability which allows viewing of many types of pictures and streaming video. As wireless networks have been upgraded to improve connection speed and reliability, more and more mobile applications and services have emerged. One example of such a mobile service is the multimedia broadcast multicast service (MBMS). MBMS refers to a point to multipoint broadcast arrangement in which multimedia such as streaming video and mobile television, for example, may be broadcast via wireless networks. The video may be viewed on, or downloaded to a user's personal communication device. However, many such devices have low resolution monitors or viewing screens. Since the MBMS formatted video feed typically targets such devices, the video format itself may only provide limited resolution. However, as higher resolution viewing screens become available for personal communications devices, it may be desirable to have an MBMS feed with increased resolution.

### SUMMARY

Various embodiments of a portable computer system including wireless functionality are disclosed. In one embodiment, a portable computer system such as a laptop computer, for example, includes a processor and a wireless module that may establish a wireless connection to a wireless network and may receive video data such as an MBMS video stream, for example, via one or more wireless channels of the wireless connection. The portable computer system also includes a first display that is coupled to the processor and a second display coupled to the wireless module. The second display may have a lower resolution than the first display, and may display first video images associated with the video data. Upon request by a user of the portable computer system, the wireless module may further receive enhancement video data via one or more additional wireless channels of the wireless connection. The first display may display second video images associated with a combination of the video data and the enhancement video data. The second video images have a higher resolution than the first video images.

### BRIEF DESCRIPTION OF THE DRAWINGS

FIG. 1 is a block diagram of one embodiment of a portable computer system including wireless communication functionality.

FIG. 2 is a diagram of one embodiment of the portable computer system of FIG. 1 being used in a wireless network.

FIG. 3 is a flow diagram describing the operation of one embodiment of the portable computer system of FIG. 1.

FIG. 4A is a perspective view drawing of one embodiment of the portable computer system of FIG. 1.

FIG. 4B is a perspective view drawing of another embodiment of the portable computer system of FIG. 1 with the cover in a closed position.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. It is noted that the word “may” is used throughout this application in a permissive sense (i.e., having the potential to, being able to), not a mandatory sense (i.e., must).

### DETAILED DESCRIPTION

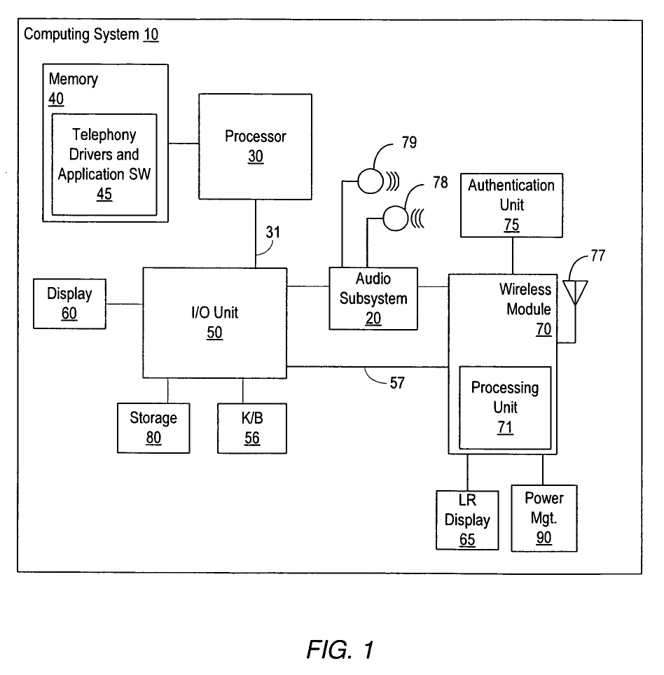

Turning now to FIG. 1, a block diagram of one embodiment of a portable computer system including wireless functionality is shown. Portable computer system 10 includes a processor 30 coupled to a memory 40 and to an input/output (I/O) unit 50. I/O hub 50 is coupled to various I/O devices such as a display 60, a storage device 80, a keyboard 56, and a wireless module 70. Wireless module 70 is coupled to a low-resolution display 65, a power management unit 90, and an authentication unit 75. In addition, an audio subsystem 20 is coupled between I/O unit 50 and wireless module 70.

It is noted that computer system 10 may include various other components and circuits that have been omitted for simplicity. It is further noted that the components of the computing subsystem are depicted in FIG. 1 for illustrative purposes. It is contemplated that the functionality associated with the various components may be distributed differently such that the lines between blocks may be drawn differently. Moreover, it is entirely possible that the functionality shown in FIG. 1 may be implemented on a single integrated circuit chip, such a system on a chip (SOC) implementation, as desired.

In the illustrated embodiment, processor 30 may be illustrative of a microprocessor that implements the x86 architecture. Although in other embodiments, processor 30 may be any type of processor implemented with any type of architecture. In one embodiment, processor 30 may include a memory controller (not shown) to facilitate memory transactions directed to memory 40, for example. In addition, processor 30 may include various interface circuits such as a host interface (not shown) for controlling transactions with I/O unit 50.

I/O unit 50 may be any of a variety of I/O controllers that may include bridging circuits (not shown) that may be used as interfaces between processor 30 and the various I/O devices, displays, and buses to which it is coupled. For example, in one embodiment, I/O unit 50 may be coupled to processor 30 via a HyperTransport™ link 31. In such an embodiment, I/O unit 50 may include one or more HyperTransport™ to peripheral component interconnect (PCI) and/or a HyperTransport™ to universal serial bus (USB) bridges for connection to PCI and USB devices, respectively, for example. In addition, in one embodiment, I/O unit 50 may be coupled to wireless module 70 via a USB, HyperTransport™ or other type of link 57, although other interconnects are contemplated. Further, I/O unit 50 may include graphics circuits (not shown) and graphics functionality for generation of the various signals used in association with display 60 and LR display 65, for example.

The audio subsystem 20 may include audio functionality including analog-to-digital and digital to-analog circuits for generation of the various signals associated with microphone 79 and speaker 78, for example.

Storage 80 may be a mass storage device. For example, in one embodiment storage 80 may include one or more hard disk drives. In other embodiments, storage 80 may include other types of storage media such as a non-volatile random access memory (RAM) device (e.g., a memory stick, flash drive, etc.), compact disk (CD) drive, digital video disk (DVD) drive, tape drive, floppy drive, and the like.

In one embodiment, display 60 may be a liquid crystal display (LCD) or other type of displays such as may be common to portable laptop and notebook computers. In contrast, LR display 65 may be a display such as the type of display used on a mobile telephone or a personal digital assistant (PDA) for example. In one embodiment, LR display 65 may have a lower resolution than display 60. As will be described in greater detail below, in some modes of operation of portable computer system 10, LR display 65 may be used exclusively, while in other modes, display 60 may be used exclusively, and in still other modes, both displays may used concurrently.

As shown, wireless module 70 is coupled to an antenna 77. Wireless module 70 includes a processing unit 71. Wireless module 70 may include the functionality of a wireless communication device such as a mobile telephone, for example. As such, in one embodiment, processing unit 71 may execute instructions and perform functions, and may include analog, digital, radio frequency (RF) and baseband circuits (not shown) that may function to perform such tasks as RF signal reception and transmission, up-conversion and down-conversion of the RF signals, analog-to-digital conversion, digital-to-analog conversion, digital signal processing of the baseband signals, graphics functions for display control, as well as monitoring and control functions. Accordingly, in various implementations, processing unit 71 may include hardware that includes a separate processor such as an advanced RISC machine (ARM) processor, for example, a digital signal processing unit, and/or one or more hardware accelerators for handling complex algorithms.

Wireless module 70 may communicate with a wireless network, such as a wireless telephone network, for example. The wireless network may conform to any of a variety of communication standards that may be compatible with various technologies such as the second (2G), third (3G) and fourth (4G) generation mobile phone technologies. In addition, the wireless network may be a wireless wide area network implemented using such protocols as WiMax, WiBro, NextNet, and others. More particularly, in various embodiments, wireless module 70 may employ a time-division multiple access (TDMA), a code division multiple access (CDMA) and/or a wideband CDMA (WCDMA) technique to implement standards such as the Global System for Mobile Communications (GSM) standard, the Personal Communications Service (PCS) standard, and the Digital Cellular System (DCS) standard, for example. In addition, many data transfer standards that work cooperatively with the various technology platforms may also be supported. For example, wireless module 70 may also implement the General Packet Radio Service (GPRS) standard, the Enhanced Data for GSM Evolution (EDGE) standard, which may include Enhanced General Packet Radio Service standard (E-GPRS) and Enhanced Circuit Switched Data (ESCD), and the high speed circuit switched data (HSCSD) standard, high speed downlink packet access (HSDPA), high speed uplink packet access (HSUPA), evolution data optimized (EV-DO), among others.

In one embodiment, memory 40 may be a system memory that is used to store instructions and data that may be used by processor 30 as well as other devices (e.g., I/O unit 50). In various embodiments, memory 40 may be implemented using any of a variety of volatile or non-volatile memory devices. For example, memory 40 may be implemented using any number of memory devices in the dynamic RAM family of devices. In one embodiment, memory 40 may be implemented using removable or non-removable memory modules with the memory devices affixed thereto. However, other memory device configurations are possible and contemplated.

As shown, memory 40 includes telephony drivers and application software 45 stored therein. It is noted that telephony drivers and application software 45 may be stored more permanently within storage 80 and during run time, at least portions of the instructions and data being executed by processor 30 may be loaded into memory 40.

Portable computer system 10 may include a computing subsystem and a wireless subsystem. In one embodiment, the computing subsystem may include the components that typically make up a general computing platform. For example, the computing subsystem may include processor 30, memory 40, I/O unit 50, display 60, and so on. The wireless subsystem may include wireless module 70, which includes processing unit 71, and LR display 65, and authentication unit 75. As will be described in greater detail below, in one embodiment, portable computer system 10 may operate in various modes. It is contemplated that the system architecture of the computing subsystem may follow a more conventional Personal Computer (PC) architecture that uses a Northbridge and/or Southbridge arrangement. However, this type of architecture is also well-known and is not discussed here for brevity. It is worth mentioning that in such a system, the wireless module 70 may be connected to the Northbridge via any type of interconnect such as a USB link, for example.

During operation of portable computer system 10, either subsystem may be used alone, or both subsystems may be used together in various combinations. For example, in one mode, portable computer system 10 may operate such that only the wireless module 70 may be in operation while the computing subsystem components may be in a standby or low power state. As such, portable computer system 10 may be operated as a wireless communication device such as a mobile telephone or a personal digital assistant (PDA). In such an embodiment, LR display 65 may be used. In another mode, the wireless subsystem may be turned off or placed in a standby mode and portable computer system 10 may operate simply as a laptop or notebook computer. In still other modes, portable computer system 10 may operate using various combinations of computing and wireless communication functionality. It is noted that while portable computer system 10 is operated in the different modes, one or more components may be powered down or placed in a standby mode or other low power states. As such, portable computer system 10 includes a power management unit 90 that may manage the different modes and power states and any switching therebetween.

Depending upon the application software and drivers that may be installed, portable computer system 10 may function as a laptop computer with a fully integrated wireless communication platform that includes voice and data transfer functionality. In addition, due to the integration of the wireless hardware and the telephony drivers and application software 45 on the portable computing platform, the management of various email, address books, and other files may be seamless to a user. For example, the telephony drivers and application software 45 may include instructions that may be used to configure the wireless module 70. In one implementation, a user may select a driver via the operating system or other mechanism, for example. The driver may configure one or more operational characteristics and/or behaviors of wireless module 70. In addition, the telephony drivers and application software 45 may be used to manage email, address books, phone lists, databases, calendars, and other information traditionally used on a mobile telephone. The application software may also include applications that may be run by processor 30 such as spreadsheet, word processing, games, graphics, and the like. Once the user configures the system operation, such operations as managing general IP data traffic, receiving incoming calls, sending outgoing calls, receiving and sending email, and display management may be fully automated from a platform user perspective.

In one embodiment authentication unit 75 may be a device such as a smart card implemented as a subscriber identity module (SIM) card, for example. As such, authentication unit 75 may also include processing functionality configured to generate cryptographic key/signature information. In one embodiment, authentication unit 75 may be used to store a unique number such as the private key of an asymmetric cryptography key pair. The private key may be generated from a unique personal identification number, or the telephone number of the unit, for example. For example, in addition to the unique personal identification number, a unique cryptographic key may be used as a seed value to generate other keys and signatures. The signatures may be used during authentication sequences between the wireless module 70 and the wireless network or other service providers. In one implementation, authentication unit 75 may provide the unique key to wireless module 70, which may be used to uniquely identify to the network the identity of the portable computer system 10. As such, processing unit 71 may be configured to generate key and signature information.

In another implementation, since authentication unit 75 may include processing functionality to generate cryptographic key information, the wireless network may present a challenge to wireless module 70 when wireless module 70 establishes a connection to the network, along with randomly generated number. The randomly generated number may be used with the unique cryptographic key to generate a signature. Wireless module 70 may provide the randomly generated number to authentication unit 75, which may generate the signature. The signature may be sent by wireless module 70 to the network. If the network-generated signature matches the signature generated by authentication unit 75, then the network authenticates portable computer system 10 as being a valid user.

In a similar manner, wireless module 70 may establish an authenticated wireless session with a computer network or service provider via the wireless network using another set of cryptographic keys. For example, using a similar authentication process, the computer or provider network may challenge wireless module 70 and provide a different randomly generated number. Wireless module 70 may provide the new randomly generated number to authentication unit 75, which may generate another signature. This signature may be sent by wireless module 70 to the computer network. If the network-generated signature matches the new signature generated by authentication unit 75, then the computer network or provider may authenticate portable computer system 10 as being an authorized user.

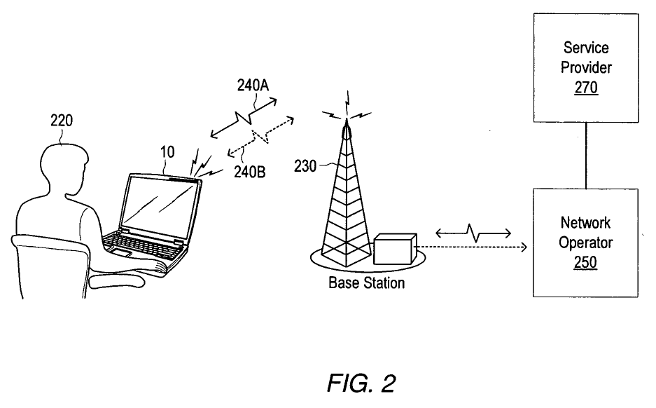

As mentioned above, portable computer system 10 may be used to connect to a wireless network. More particularly, as shown in FIG. 2, a user may, during normal operation, establish and maintain connection to a wireless network while working at a remote location, or while traveling in a vehicle as long as a wireless connection can be established (i.e., a transmitter is in range). For example, the user may establish a wireless connection to a wireless wide area network via an IP protocol, connect to one or more base stations 230 of a wireless telephone network by placing a telephone call, via the air interface, among others. Subsequent to establishing the connection, the user may perform a variety of tasks such as transfer data or browse the Internet using a web browser, for example.

In one embodiment, while the user is using the wireless connection, wireless module 70 may be configured to receive an MBMS signal or other video signals such as DVB-H or MediaFLO, for example, on one or more channels from a service provider. As described above, the MBMS signal may be received in a low resolution format as part of a basic use service package. However, in some markets, the user may be able to receive a higher resolution MBMS signal on demand. For example, the user may request the higher resolution feed, which in some cases, may require an additional charge such as may be the case in a pay-per-view arrangement. In one embodiment, the higher resolution may be obtained by receiving an enhancement video data stream that may fill in or supplement the video data. For example, the enhancement video data may be used for infilling or sub-pixel rendering of the basic video data to create it higher resolution images. Accordingly, the MBMS service may provide the enhancement data stream information via one or more additional or “side” channels. As such, the higher resolution video images may be displayed on display 60 instead of display 65. It is noted that the enhancement data stream may not be used without the video feed provided by the basic use service.

Referring to FIG. 2, a diagram depicting one embodiment of the portable computer system of FIG. 1 being used in wireless wide area network is shown. A user 220 is operating portable computer system 10. As shown, portable computer system 10 is a laptop or notebook computer, although other form factors having similar functionality are contemplated. As described above, portable computer system 10 may connect to one or more base stations 230 of a wireless network via the air interface. The base station 230 may provide a connection to a network operator 250. A service provider 270 such as an digital content provider may provide an MBMS video feed to network operator 250 for transmission on the network. As described above, the a basic use MBMS signal may be received on one or more channels 240A, and an enhancement data stream may be received on one or more side channels 240B, when requested.

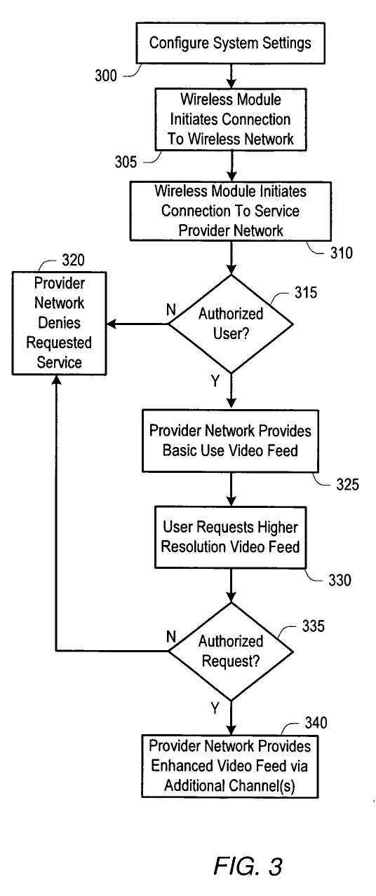

FIG. 3 is a flow diagram describing the operation of one embodiment of the portable computer system shown in FIG. 1. Referring collectively to FIG. 1 through FIG. 3, beginning in block 300, a user (e.g., 220) may configure operation of the wireless module 70 by selecting one or more drivers. For example, passwords and other authentication information may be entered and stored, low-power state operation may be selected, remote access (e.g., IP address) information may be entered, and so on.

Once the system settings have been configured, the user may establish a wireless connection to the Internet using an IP protocol, or by via dial-up by calling a telephone number to an ISP, or other network provider 250, for example (block 305). During normal operation, the user may decide to view a streaming video, or a movie, or the like. Accordingly, they user may initiate a connection to a given service provider (e.g., 270) that may provide digital content in the form of an MBMS formatted signal. As such wireless module 70 may establish the connection as described above. For example, one or more authentication mechanisms may allow the service provider to authenticate the user (block 310). If the service provider 270 determines that the user is not authorized for a given reason (block 315), the service provider 270 may deny the requested service (block 320). If, on the other hand, the service provider 270 determines the user is authorized to obtain the content (block 315), the service provider 270 may provide the MBMS signal to the network provider 250, who may in turn begin streaming the basic use video feed over one or more wireless channels (block 325).

Since portable computer system 10 also includes a higher resolution display (e.g., display 60) available, the user may request to the service provider 270 a high resolution format of the MBMS video feed (block 330). Depending upon the specific service arrangement, the service provider 270 may determine whether the user is authorized to receive the extended MBMS service (block 335). For example, the user may or may not be pre-authorized to purchase extended services. If the user is not authorized, the service provider 270 may deny the requested service as described above in block 320. However, if the user is authorized to obtain the content (block 335), the service provider 270 may provide the extended MBMS signal to the network provider 250, who may in turn begin streaming the enhancement video feed over one or more additional side wireless channels (block 340).

As described above, the enhancement video feed data may be used in combination with the basic video feed data by graphic circuits (e.g., graphic circuits within I/O unit 50) to create higher resolution video images than is possible with just the basic video feed. Depending on the specific implementation, the enhancement video may be used to infill the basic video, for example.

It is noted that in other embodiments, the user may be able to configure the system settings such that upon making the initial request for the MBMS video stream, the service provider may automatically send the extended MBMS signal based upon the user's preferences.

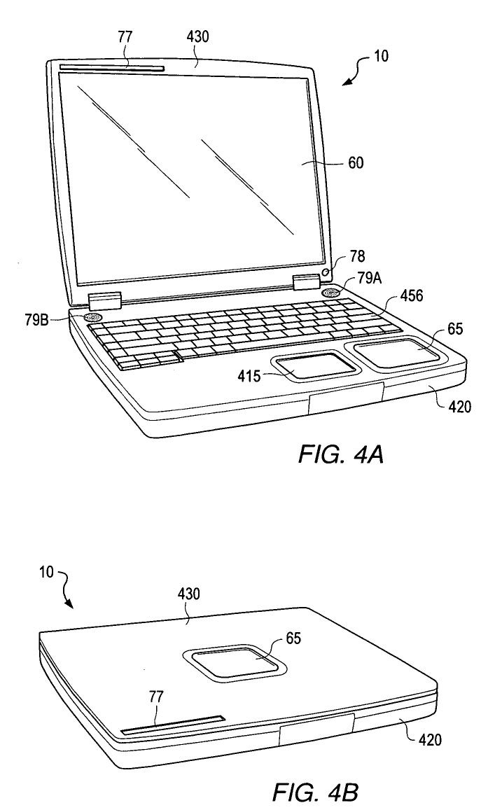

FIG. 4A and FIG. 4B are perspective view drawings of one embodiment of portable computer system 10 shown in FIG. 1. More particularly, the embodiment of portable computer system 10 shown in FIG. 4A depicts personal computer system as a laptop computer (i.e., a notebook computer) that includes a housing 420 with a hingably attached cover 430 that is in an open position. FIG. 4B depicts another embodiment of the portable computer system 10 with cover 430 in a closed position with LR display 65 visible and useable when cover 230 is in the closed position.

Referring to FIG. 4A, the cover 430 includes a display 60 such as an LCD, microelectro-mechanical (MEMS), or electronic ink (Eink), for example, that forms a part of the internal surface of the cover. In addition, in the illustrated embodiment, portable computer system 10 includes an antenna 77 that is mounted to cover 430. It is noted that the mounting location, type, and numbers of antenna 77 are implementation details. Accordingly, although antenna 77 is shown mounted to the inside of cover 430, in other embodiments, antenna 77 may be mounted to cover 430 or housing 420, or even internal to housing 420 as desired. In addition, antenna 77 may go entirely or partially around display 60.

Portable computer system 10 also includes a microphone 78, speakers 79A and 79B, and a keyboard 456, and a touch activated mouse control 415 that are mounted on a top surface of the housing 420. In addition, portable computer system 10 includes an additional display unit (e.g., LR display 65) mounted to the top surface of housing 420. As described above, in one embodiment, display 65 may be a low-resolution display. In various other embodiments, LR display 65 may also be an input device (e.g., touch-activated screen) to facilitate use of a pointing device such as a stylus, for example. As such, LR display 65 may include analog-to-digital conversion circuits to input data from the screen. It is noted that the location and type of LR display 65 are also implementation details. As such, LR display 65 may be located in any desired location, another example of which is shown in FIG. 4B.

Referring to FIG. 4B, the embodiment of portable computer system 10 shown in FIG. 4B is similar to the embodiment shown in FIG. 4A. However, the embodiment of portable computer system 10 shown in FIG. 4B does not include LR display 65 mounted on the top surface of housing 420. Instead, as illustrated in FIG. 4B, LR display 65 is mounted on the external surface of cover 430 such that LR display 65 is visible and useable when cover 430 is in the closed position. In addition, as noted above, in the illustrated embodiment, antenna 77 is mounted on the external surface of cover 430, but may be mounted internal to housing 420, or any other location, as desired.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A portable computer system comprising:
a processor;
a first display coupled to the processor;
a wireless module coupled to the processor and configured to establish a wireless connection to a wireless network and to receive video data via one or more wireless channels of the wireless connection; and
a second display coupled to the wireless module, wherein the second display has a lower resolution than the first display, wherein the second display is configured to display first video images associated with the video data;
wherein upon request by a user, the wireless module is further configured to receive enhancement video data via one or more additional wireless channels of the wireless connection; and
wherein the first display is configured to display second video images associated with a combination of the video data and the enhancement video data, wherein the second video images have a higher resolution than the first video images.

2. The portable computer system as recited in claim 1, wherein the video data comprises a video data stream.

3. The portable computer system as recited in claim 1, wherein the enhancement video data comprises additional video data for use during image rendering to create the second video images.

4. The portable computer system as recited in claim 1, wherein the video data comprises a multimedia broadcast multicast service (MBMS) video data stream sent in a point-to-multipoint configuration upon one or more channels of the wireless connection.

5. The portable computer system as recited in claim 4, wherein the wireless module is further configured to generate the first video images for the second display.

6. The portable computer system as recited in claim 1, further comprising an input/output (I/O) unit coupled to the processor and configured to generate the second video images.

7. The portable computer system as recited in claim 1, further comprising an authentication unit coupled to the wireless module and configured to generate authentication information for use when requesting the enhancement video data from a provider.

8. A system comprising:
a service provider configured to provide video data to a portable computer system via one or more channels of a wireless connection;
wherein the video data corresponds to video images having a first resolution;
wherein upon receiving a valid request, the service provider is further configured to provide enhancement video data to the portable computer system via one or more side channels of the wireless connection;
wherein a combination of the video data and the enhancement video data corresponds to second video images having a second resolution that is higher than the first resolution.

9. The system as recited in claim 8, wherein the video data comprises a multimedia broadcast multicast service (MBMS) video data stream sent in a point-to-multipoint configuration upon one or more channels of the wireless connection.

10. A method comprising:
establishing a wireless connection from a portable computer system to a wireless network;
the portable computer system receiving video data via one or more wireless channels of the wireless connection;
displaying on a first display of the portable computer system, first video images associated with the video data;
receiving enhancement video data via one or more additional wireless channels of the wireless connection; and
displaying on a second display of the portable computer system, second video images associated with a combination of the video data and the enhancement video data;
wherein the second display has a higher resolution than the first display; and
wherein the second video images have a higher resolution than the first video images.

11. The method as recited in claim 10, wherein the video data comprises a video data stream.

12. The method as recited in claim 10, wherein the enhancement video data comprises additional video data for use during image rendering to create the second video images.

13. The method as recited in claim 10, wherein the video data comprises a multimedia broadcast multicast service (MBMS) video data stream sent in a point-to-multipoint configuration upon one or more channels of the wireless connection.

14. The method as recited in claim 13, further comprising a wireless module of the portable computer system generating the first video images for the first display.

15. The method as recited in claim 10, further comprising an input/output (VO) unit of the portable computer system generating the second video images.

16. The method as recited in claim 10, further comprising an authentication unit of the portable computer system generating authentication information for use when requesting the enhancement video data from a provider.
